(19) United States
(12) Patent Application Publication
(10) Pub. No.: US 2014/0033606 A1
(43) Pub. Date: Feb. 6, 2014

(54) Apparatus and Method for Holding Rooting Media

(71) Applicant: DeFrank Joseph, Mililani, HI (US)

(72) Inventor: DeFrank Joseph, Mililani, HI (US)

(21) Appl. No.: 14/050,327

(22) Filed: Oct. 9, 2013

Related U.S. Application Data
(63) Continuation of application No. 12/888,332, filed on Sep. 22, 2010, now abandoned.
(60) Provisional application No. 61/277,381, filed on Sep. 23, 2009.

(51) Int. Cl. A01G 9/00

(52) U.S. Cl. CPC A01G 9/00
USPC 47/5.5

(57) ABSTRACT

A wrap for use in air-layering made from a long tubular plastic net sack filled with a rooting media. The sack is used for secure placement of the rooting media about the plant surface. Furthermore, a method for air layering large woody plant is provided that comprises of placing the wrap containing the rooting media, over the plant surface.

### RELATED APPLICATIONS

The present application claims priority under 35 U.S.C. §119(e) to United States Provisional Patent Application No. 61/277,381, filed Sep. 23, 2009, and which is fully incorporated herein by reference.

### FIELD OF THE INVENTION

The present invention relates to an apparatus and method for plant propagation through air layering, and more particularly, to a wrap for holding a rooting media in an air layering medium.

### BACKGROUND

Plant propagation is the process for distributing or spreading plants artificially or naturally, using plant parts. Gardeners, agriculturists, and horticulturists use plant propagation for cloning plants rapidly, or for raising crops like bananas, sugarcane, potatoes, and the plants which do not produce viable seeds. Seeding, using rhizomes and related organs, layering, division and grafting are examples of conventional methods for plant propagation. Over the years, these methods have constantly been improved by scientific advances in plant physiology, biochemistry, and environmental studies.

Layering is relatively simply method to grow new plants from old plants, and this method has evolved as a general means for vegetative propagation in natural environments. The principle of layering is to encourage development of new roots on a stem while the stem is still attached to the parent plant. The rooted stem is then detached to become a new plant growing on its own root system. There are six common types of layering: air, simple, tip, trench, serpentine, and mound. Amongst these, air layering and simple layering are the most common types.

In air layering, the target region on the stem is girdled to remove surface bark and underlying cambium layer and then enclosed in a moisture-retaining wrapper such as Sphagnum moss that is further enclosed in a moisture barrier such as a polyethylene film or aluminum foil. Usually, several weeks after a layer is made, the root formation will begin and a new, compact plant can be seen. The air layering technique is especially useful for propagating houseplants, such as croton, philodendron, camellia, rubber plants, as well as elite selections of trees that are used for wood products, fruits and flowering, and as landscape ornamental plants.

The air layering method requires the use of properly moistened Sphagnum moss in an appropriate amount to induce root formation. This is accomplished by introducing an adequate amount of Sphagnum moss, and moistening the Sphagnum moss accordingly. The Sphagnum moss is then applied over the prepared area on the limb, and this area is wrapped by a plastic sheet, or an equivalent, to hold the Sphagnum moss securely in place. It is necessary to wrap the Sphagnum moss in a correct manner to prevent constriction of conducting tissues that bring water, nutrients and hormones to the root induction zone of the air layer and to exclude insects that can infest the prepared area.

The use of traditional technology for layering requires wrapping a plastic sheet over Sphagnum moss while the user supports the Sphagnum moss with one hand, which makes it difficult for an unskilled person to perform the operation. Various devices have been proposed in prior arts that provide a means for holding the Sphagnum moss or rooting media on the prepared area. However, these devices have limitations since they are intended to enclose a limb with a specific diameter, and for different sized and shaped limbs, a separate device has to be prepared. Furthermore, it is relatively difficult for an unskilled person to judge the correct amount of Sphagnum moss that may be required, as well as difficult to distribute the Sphagnum moss uniformly with a sufficient thickness over the area to be used for root formation. These limitations cause the entire process to be complicated and time consuming for air layering large woody stems, especially when working off of the ground.

In light of the foregoing discussion, there is a need of a simple method that provides a secure placement of the rooting media about the plant surface, where the root formation will take place and which facilitates hands-free wrapping of a cover over the rooting media.

### BRIEF SUMMARY OF THE INVENTION

In an embodiment, the present invention relates to a method of air-layering a plant limb, the method comprising the steps of: removing an outer bark layer from a plant limb to create an exposed limb portion; removing a cambium layer from the exposed limb portion; applying a rooting hormone to the upper portion of exposed limb; wrapping a mesh container filled with a rooting media circumferentially around the exposed limb portion; and covering the mesh container and the exposed limb portion with a plastic film.

In another embodiment, the present invention relates to a method of preparing a wrap for air-layering a plant limb, comprising the steps of: filling a mesh sheet having two opposite ends with a rooting media; comparing the mesh sheet with a diameter of a plant limb; adjusting the mesh sheet so that the mesh sheet circumferentially wraps around a plant limb; wrapping the mesh sheet around the plant limb; securing the opposite ends of the mesh sheet with a fastener; and covering the mesh sheet with a plastic film.

In another embodiment, the present invention relates to an apparatus for air-layering a plant limb, comprising: a mesh sheet having a first layer and a second layer, the mesh sheet further having two opposite ends; a rooting media placed between the first layer and the second layer; a fastener secured to each of the two opposite ends; a plastic sheet circumferentially wrapping the mesh sheet.

An object of the present invention is to provide an improved, effective, economical and simple method for air layering that allows hands-free wrapping of the plastic film over the rooting media.

Another object of the present invention is to provide a wrap for placing the rooting media on the plant surface.

Another object of the present invention is to provide a wrap that facilitates the uniform distribution of rooting media over the limb with different diameters.

Another object of the present invention is to hold roots firmly in place during the removal of the air layer from the parent plant and during planting to a nursery, field planting or during shipment of the unpotted plant.

### BRIEF DESCRIPTION OF THE DRAWINGS

The preferred embodiments of the invention will hereinafter be described in conjunction with the figures provided herein to further illustrate various non-limiting embodiments of the invention, wherein like designations denote like elements, and in which:

FIG. 1 is a block diagram illustrating an exemplary method for air-layering woody plants, in accordance with an embodiment of the present invention.

FIG. 2 illustrates a net sack, in accordance with an embodiment of the present invention.

FIG. 3 illustrates a wrap comprising a net sack filled with a rooting media, in accordance with an embodiment of the present invention.

FIG. 4 illustrates a wrap held in place on the girdled portion of the limb, in accordance with an embodiment of the present invention.

FIG. 5 illustrates a plastic film enveloped around the wrap, in accordance with an embodiment of the present invention.

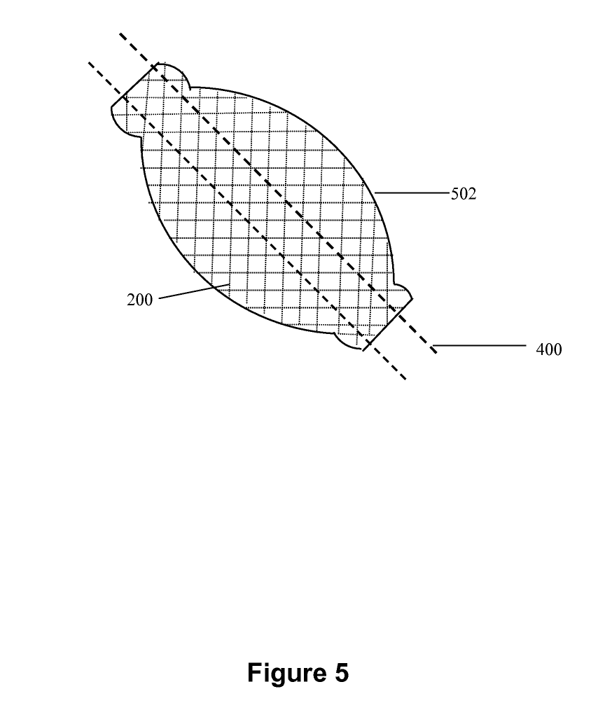

### DETAILED DESCRIPTION OF EMBODIMENTS

In the following detailed description of embodiments of the invention, numerous specific details are set forth in order to provide a thorough understanding of the embodiments of the invention. However, it will be obvious to a person skilled in the art that the embodiments of the invention may be practiced with or without these specific details. In other instances well-known methods, procedures, and components have not been described in details so as not to unnecessarily obscure aspects of the embodiments of the invention.

Furthermore, it will be clear that the invention is not limited to these embodiments only. Numerous modifications, changes, variations, substitutions, and equivalents will be apparent to those skilled in the art without parting from the spirit and scope of the invention.

In an embodiment of the present invention, a method for air layering woody plants is provided. The method comprises: taking a long tubular plastic net sack; filling the sack with a rooting media forming a wrap; stripping the bark off a tree, a process referred to as girdling; scrapping the wet cambium layer of the limb; applying a rooting hormone on the upper portion of limb; preparing a wrap by filling a long tubular plastic net sack with the moistened rooting media; cutting the wrap in desired length to accommodate the prepared limb; placing the wrap about the prepared limb; tying the wrap using a fastening means; and enclosing the wrap by a plastic film to retain moisture. The rooting media is the moistened Sphagnum moss.

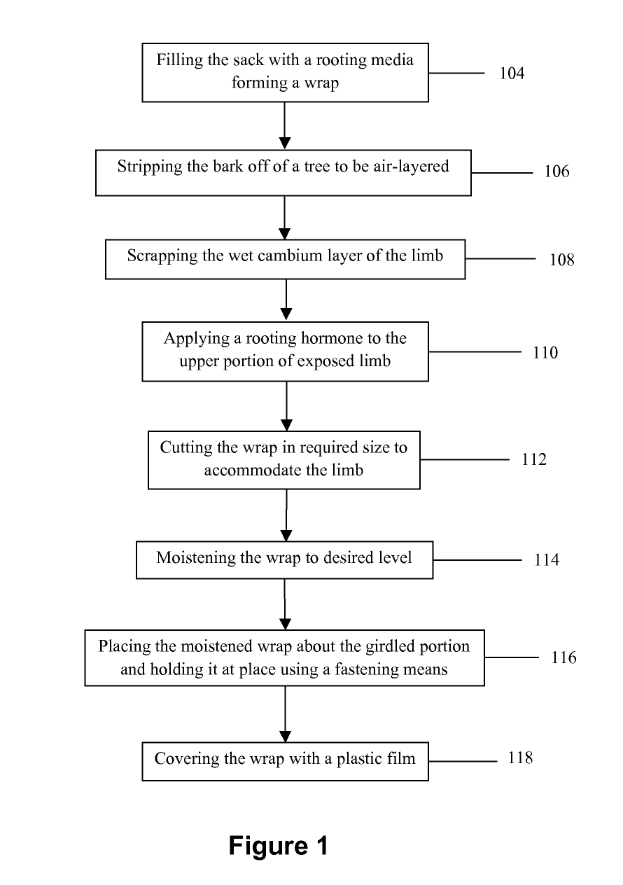

FIG. 1 is a block diagram illustrating an exemplary method for air-layering woody plants, in accordance with an embodiment of the present invention. In an embodiment of the present invention, the method includes the following steps: Step 102: taking a net sack having mesh of plastic fibers; Step 104: Filling the net sack with a rooting media forming a wrap; Step 106: Stripping the bark of a tree to be air layered. This process is called girdling, and the girdling can be done alone or in premixed combinations; Step 108: Scrapping the wet cambium layer of the limb; Step 110: Applying a rooting hormone to the top side of the girdled limb; Step 112: Cutting the wrap in required size so as to accommodate the limb to be air layered; Step 114: moistening the wrap to the desired level; Step 116: Placing the wrap about the limb surface and holding it in place using a fastening means; Step 118: Covering the wrap with a plastic film.

In an embodiment, the rooting media is Sphagnum moss, or any other peat, peat moss, or substance that can be used as a soil conditioner that increases the soil's capacity to hold water and nutrients by increasing capillary forces and cation exchange capacity. Examples of such soil conditioners include, but are not limited to, top soil, rooting composts, silt, sawdusk, and husk.

The rooting hormone applied in Step 110 can be a plant growth hormone, phytohormone, plant growth substance, or any other substance that promotes and influences plant root formation. Examples of suitable substances include, but are not limited to, abscisic acid, auxins, cytokinins, gibberellins, salicyclic acid, jasmonates, plant peptide hormones, polyamines, strigolactones, and karrikins.

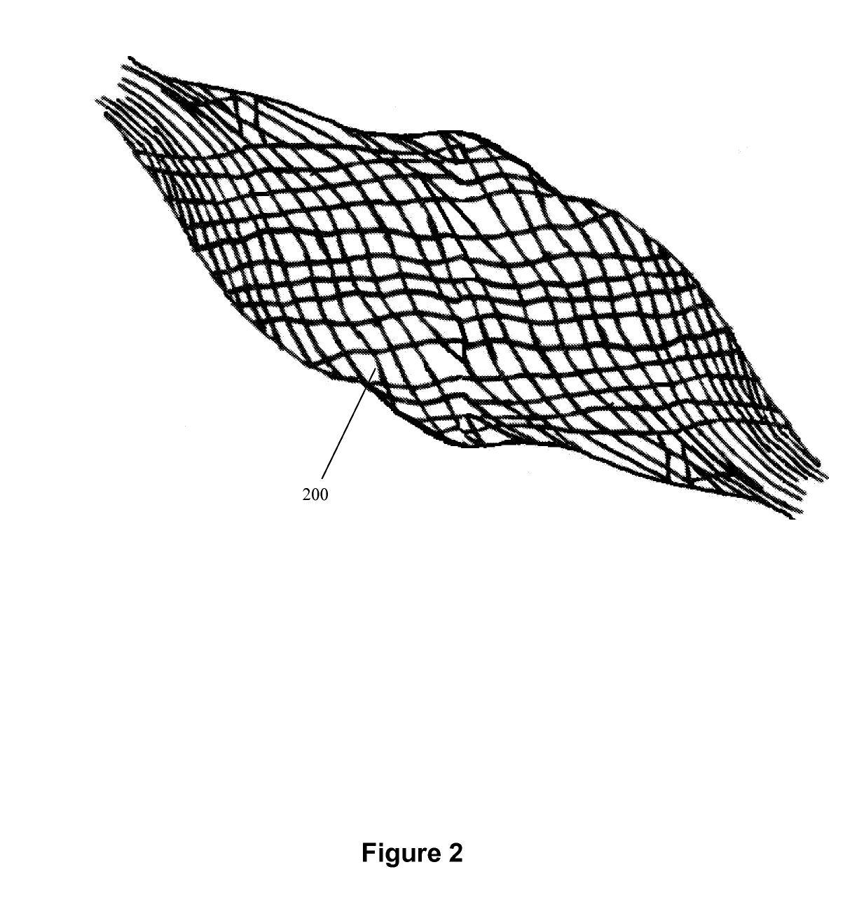

FIG. 2 illustrates a net sack 200, in accordance with an embodiment of the present invention. The sack 200 comprises a mesh of plastic fibers interwoven with each other resulting in a net like structure. The plastic sack 200 is in a tubular shape and thus a rooting media can be filled conveniently. The length of plastic sack 200 is in meters. Use of a long tubular plastic sack 200 has an advantage that it can be cut into different sizes according to the diameter of the limb to be air-layered. Thus, a single sack can be used to accommodate various-sized limbs and branches, and can be used for multiple types of plants.

The mesh of plastic fibers can be made of polyethylene such as LDPE, LLDPE, UHMWPE, HDPE, PEX, MDPE, VLDPE, etc. Alternatively, the mesh of plastic fibers can be made from other thermoplastic polymers, laminates and co-extrusions having similar properties as polyethylene.

In an alternative embodiment of the present invention, the net sack can be made of cotton fibers or organic fibers to facilitate decomposition of the net sack when the newly formed plant is planted in pots or ground.

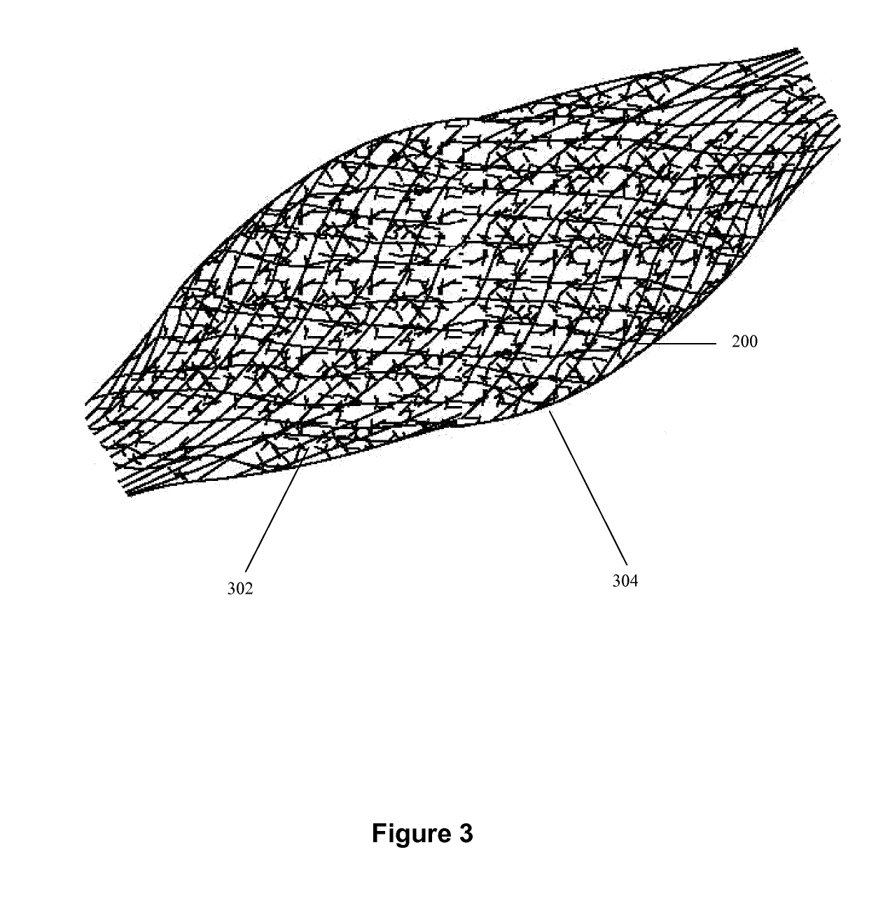

FIG. 3 illustrates a wrap 304 comprising a net sack 200 filled with a rooting media 302, in accordance with an embodiment of the present invention. In an embodiment of the present invention, a wrap 304 for placing a rooting media 302 over the plant surface is provided. The wrap 304 is a long tubular plastic net sack 200 filled with an appropriate amount of the rooting media 302. The wrap 304 can be cut into desired length to enclose the limb to be air layered. The use of wrap 304 in long tubular form eliminates the need of preparing the wraps in different sizes. The wrap 304 allows the secure placement of the rooting media 302 over the plant surface, where root formation will take place.

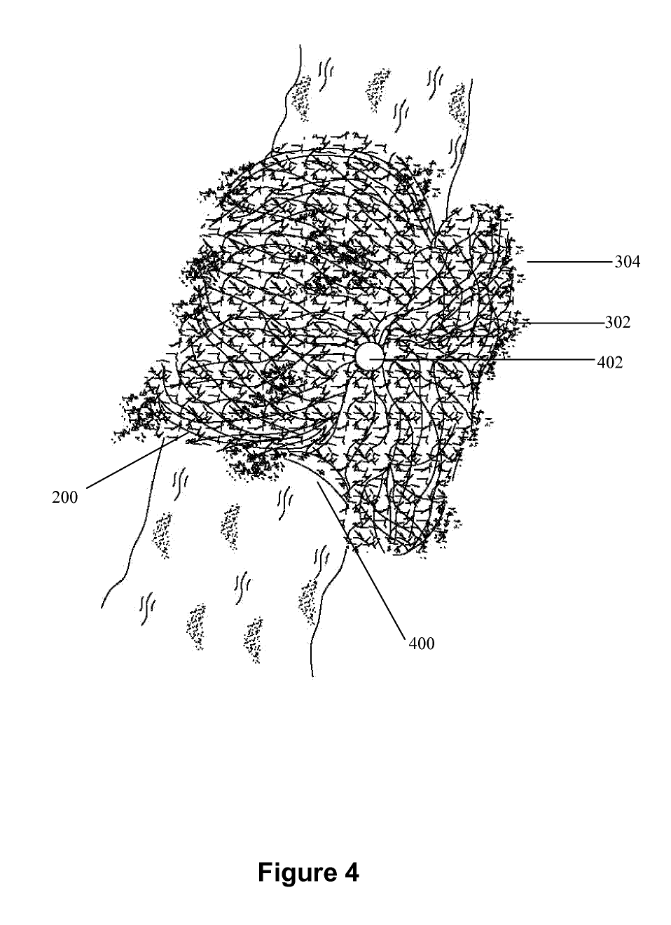

FIG. 4 illustrates the wrap 304 held at place on the prepared limb 400, in accordance with an embodiment of the present invention. The wrap 304 is fixed to the prepared limb 400 using a fastening means 402. The fastening means can include rubber bands, paper clips, ties, rope, clips, bolts, nails, staples, or any other fasteners that can secure the wrap 304 to the limb 400. The use of the fastening means 402 for fixing the wrap 304 facilitates the hands-free wrapping of plastic film over the wrap 304.

In an alternative embodiment of the present invention, the outer segment of the wrap 304 is pre-coated with a transparent, insulating material, thus avoiding manual enveloping of the wrap 304. The insulating material includes and is not limited to a polyethelyne sheet or a plastic sheet. This insulating material can be a plastic shrink-wrap material.

It is readily apparent that the wrap 304 facilitates the uniform distribution of the Sphagnum moss over the prepared limb 400 and makes the process simpler that can be effectively accomplished even by an unskilled person.

While the principles of this invention have been illustrated in relation to the exemplary embodiments shown herein, the principles of this invention are not limited thereto and include any modification, variation or permutation thereof

What is claimed is:

1. A method of air-layering a plant limb, the method comprising the steps of:
removing an outer bark layer from a plant limb to create an exposed limb portion;
removing a cambium layer from the exposed limb portion;
applying a rooting hormone to the upper portion of exposed limb;
wrapping a mesh container filled with a rooting media circumferentially around the exposed limb portion; and
covering the mesh container and the exposed limb portion with a plastic film.

2. The method of claim 1, wherein the outer bark layer is removed using a girdle.

3. The method of claim 1, wherein the rooting hormone is selected from a group consisting of abscisic acid, auxins, cytokinins, gibberellins, salicyclic acid, jasmonates, plant peptide hormones, polyamines, strigolactones, and karrikins

4. The method of claim 1, wherein the rooting media is selected from a group consisting of peat, peat moss, top soil, rooting composts, silt, sawdusk, and husk.

5. The method of claim 1, wherein the rooting media is Sphagnum moss.

6. The method of claim 1, wherein the mesh container is a plastic net sack.

7. The method of claim 1, wherein the plastic film is a plastic shrink-wrap.

8. A method of preparing a wrap for air-layering a plant limb, comprising the steps of:
filling a mesh sheet having two opposite ends with a rooting media;
comparing the mesh sheet with a diameter of a plant limb;
adjusting the mesh sheet so that the mesh sheet circumferentially wraps around a plant limb;
moistening the mesh sheet;
wrapping the mesh sheet around the plant limb;
securing the opposite ends of the plastic mesh sheet with a fastener; and
covering the mesh sheet with a film.

9. The method of claim 8, wherein the mesh sheet is a mesh of plastic fibers or cotton fibers interwoven with each other.

10. The method of claim 8, wherein the mesh sheet is rolled into the form of a long, tubular sack.

11. The method of claim 8, wherein the step of adjusting the mesh sheet comprises cutting the mesh sheet.

12. The method of claim 8, wherein the fastener is selected from a group consisting of rubber bands, paper clips, ties, rope, clips, bolts, nails, and staples.

13. The method of claim 8, wherein the film is made from aluminum.

14. An apparatus for air-layering a plant limb, comprising:
a mesh sheet having a first layer and a second layer, the mesh sheet further having two opposite ends;
a rooting media placed between the first layer and the second layer;
a fastener secured to each of the two opposite ends;
a plastic sheet circumferentially wrapping the mesh sheet.

15. The apparatus of claim 14, wherein the mesh sheet is a mesh of plastic fibers interwoven with each other.

16. The apparatus of claim 14, wherein the mesh sheet is made from a polyethylene material.

17. The apparatus of claim 14, wherein the fastener is selected from a group consisting of rubber bands, paper clips, ties, rope, clips, bolts, nails, and staples.

18. The apparatus of claim 14, wherein the plastic film is a plastic shrink-wrap.

19. The apparatus of claim 14, wherein the rooting media is Sphagnum moss.

20. The apparatus of claim 14, wherein the rooting hormone is selected from a group consisting of abscisic acid, auxins, cytokinins, ethylene, gibberellins, salicyclic acid, jasmonates, plant peptide hormones, polyamines, nitric oxide, strigolactones, and karrikins.
